(19) United States
(12) Patent Application Publication
(10) Pub. No.: US 2018/0270493 A1
(43) Pub. Date: Sep. 20, 2018

(54) IMAGE COMPRESSION

(71) Applicant: UNIVERSITY OF WARWICK, Coventry (GB)

(72) Inventors: Alan CHALMERS, Warwickshire (GB); Jonathan HATCHETT, Coventry, West Midlands (GB); Joshua MCNAMEE, Coventry, West Midlands (GB); Kurt DEBATTISTA, Warwickshire (GB)

(21) Appl. No.: 15/754,713

(22) PCT Filed: Aug. 22, 2016
(86) PCT No.: PCT/GB2016/052600

§ 371 Date: Feb. 23, 2018

(30) Foreign Application Priority Data
Aug. 29, 2015 (GB) 1515415.6

(51) Int. Cl. H04N 19/46; H04N 19/184; H04N 19/172; H04N 19/34

(52) U.S. Cl. CPC H04N 19/46; H04N 19/34; H04N 19/172; H04N 19/184

(57) ABSTRACT

A method of compressing and decompressing High Dynamic Range images utilising the relationship: (I) Where γ≥2.5; and (II)=compressed; and (III)=linear

$$\begin{matrix}{[ \begin{matrix}R \\ G \\ B\end{matrix} ]}_{c} = {{[ \begin{matrix}R \\ G \\ B\end{matrix} ]}_{l}^{\frac{1}{γ}} \\ [ \begin{matrix}R \\ G \\ B\end{matrix} ]}_{l} = {[ \begin{matrix}R \\ G \\ B\end{matrix} ]}_{c}^{γ} & ( I ) \\ {[ \begin{matrix}\cdot \\ \cdot \\ \cdot \end{matrix} ]}_{c} & ( II ) \\ {[ \begin{matrix}\cdot \\ \cdot \\ \cdot \end{matrix} ]}_{l} & ( III )\end{matrix}$$

This invention relates to the compression of low and high dynamic range images, whether still images or video streams.

A wide range of colours and lighting intensities exist in the real world. While our eyes have evolved to enable us to see in moonlight and bright sunshine, traditional imaging techniques, on the other hand, are incapable of accurately capturing or displaying such a range of lighting. The areas of the image outside the limited range in traditional imagery, commonly termed Low (or Standard) Dynamic Range (LDR), are either under or over exposed. High Dynamic Range (HDR) imaging technologies are an alternative to the limitations inherent in Low Dynamic Range imaging. High Dynamic Range can capture and deliver a wider range of real-world lighting to provide a significantly enhanced viewing experience, for example the ability to clearly see the football as it is kicked from the sunshine into the shadow of the stadium. High Dynamic Range techniques can be generated in a number of diverse ways, for example they may merge single exposure Low Dynamic Range images to create a picture that corresponds to our own vision, and thus meet our innate expectations. An alternate source is the output of computer graphics systems which are also typically High Dynamic Range images. Further alternative sources are High Dynamic Range imaging devices.

HDR video provides a significant difference in visual quality compared to traditional LDR video. With up to 96 bits per pixel (BPP), compared to a standard image of 24 BPP, a single uncompressed HDR frame of 1920×1080 resolution requires 24 MB, and a minute of data at 30 fps is 42 GB. In order to cope effectively with this large amount of data, efficient compression is required. Moreover, if HDR is to gain wide acceptance, and find use in broadcast, internet streaming, remote gaming, etc., it is crucial that computationally efficient encoding and decoding is possible.

HDR video compression may be classified as either a one-stream or two-stream approach. A two-stream method separates the single HDR video input stream into base and detail streams which are then compressed separately according to their individual characteristics. One-stream methods, on the other hand, take advantage of the higher bit-depth available in modern video codecs. A transfer function (TF) is used to map the HDR video input stream to a single, high bit-depth stream and optionally some metadata to aid the post-processing before display. A number of the proposed one-stream methods use complex TFs, requiring many floating-point operations for both compression and decompression.

This invention is concerned with efficient compression which is vital to ensure that the content of images or videos can be efficiently stored and transmitted.

Methods collectively known as tone mapping operators have been developed that can be applied to the High Dynamic Range content to convert it to Low Dynamic Range content that is suitable to be viewed on a traditional Low Dynamic Range displays for example (Banterle, F., Artusi, A., Debattista, K., & Chalmers, A. (2011). Advanced high dynamic range imaging: theory and practice. CRC Press).

Typically compression curves used are those typically used for Low Dynamic Range video. However, it is desired to improve in compression and quality.

In the present invention a Power Transfer Function is used. The human visual system (HVS) has greater sensitivity to relative differences in darker areas of a scene than brighter areas. This nonlinear response can be generalised by a straightforward power function. The Power Transfer Function (PTF) weights the use of the values available to preserve detail in the areas of the HDR content in which the human visual system is more sensitive. PTF therefore allocates more values to the dark regions than to the light regions.

According to the present invention a method of compressing and decompressing High Dynamic Range images comprises the step of using a power transfer function ƒ(x)=Ax^{γ} in which A is a constant, x is normalised image data contained by the set [0,1]⊂ [symbol] and γ∈ [symbol] ⁺ and in which γ is 2.5 or greater.

$$\begin{matrix}This relationship can be expressed {as [ \begin{matrix}R \\ G \\ B\end{matrix} ]}_{c} = {[ \begin{matrix}R \\ G \\ B\end{matrix} ]}_{l}^{\frac{1}{γ}} & ( 1 ) \\ {[ \begin{matrix}R \\ G \\ B\end{matrix} ]}_{l} = {[ \begin{matrix}R \\ G \\ B\end{matrix} ]}_{c}^{γ} \\ where γ \geq 2.5 ; {and \\ [ \begin{matrix}\cdot \\ \cdot \\ \cdot \end{matrix} ]}_{c} = compressed ; {and \\ [ \begin{matrix}\cdot \\ \cdot \\ \cdot \end{matrix} ]}_{l} = linear & ( 2 )\end{matrix}$$

The constant A is included as it allows us to directly scale the output of the transfer function to the number of available integers in the video encoder. This is dependent on bit depth and is described by the equation, (2ⁿ)−1 where n is the number of bits per channel. In 8-bit LDR imagery this works out to be 255 and in the 10-bit imagery, which is expected to be used for this generation of HDR, this is 1023. In the following generation where 12-bits are available the value is 4095.

A degree of optimisation for the brightness and content of the scene but for most video it has been found that γ=4 provides a best compromise, which would give a range of 4 times that of LDR (with an appropriate γ), yet maintains some sort of compatibility with LDR, bit depth scaling would then be included elsewhere. In more sophisticated systems a regression histogram curve can be used by matching properties such as but not limited to content, bit depth and target bit rate and γ is set using a best fit to the curve. In practice, for hardware reasons, the selected γ is rounded to the nearest whole number.

By using variable values of γ, say by varying the γ every frame or after a pre-set period, or when the scene changes, the quality of the reproduced image can be near its theoretical best for as long as possible. The effect of increasing the value of γ is to value in the compression process the bright well illuminated parts of a scene less highly than the darker parts, thus in compression more information about the darker, less easily seen by the human eye images, is retained whereas less information about the easily seen parts is retained. However, for most situations including 10 and 16 point videos it has been unexpectedly found that the γ=4 provides a good comprise for most situations, avoiding the need to optimise the Power Transfer Function for different situations.

γ∈ [symbol] + is derived because for a transfer function f(x) to operate f(0)=0 and f(1)=1. This is true for real numbers greater than 0 only. To provide a compressive effect γ>1 (γ=1 becomes a no-operation) and the γ used in LDR is in the range 1.8-2.4. This correlates well with human perception for the range of brightness typically displayed by LDR imagery, 0-100 nits. As the imagery gets brighter however >1000 nits, perception becomes logarithmic and a γ of around 4 provides a good compromise between the gamma based lower sections and logarithmic upper sections.

Examples of the invention will be discussed with reference to the accompanying figures in which:

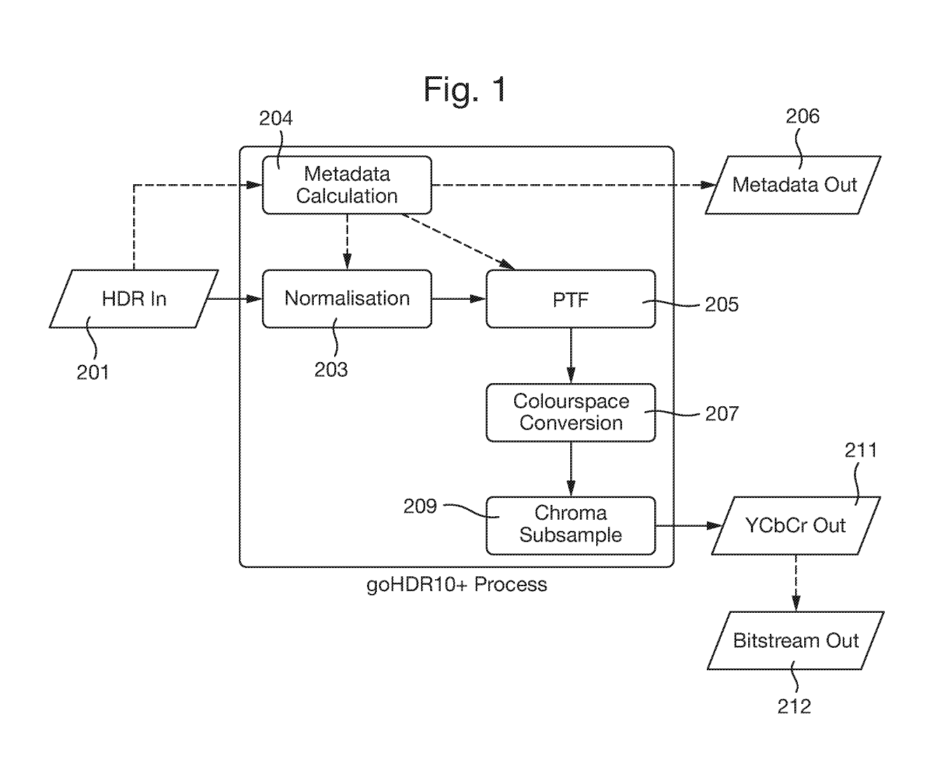

FIG. 1 shows a block diagram of encoding HDR using of the present invention;

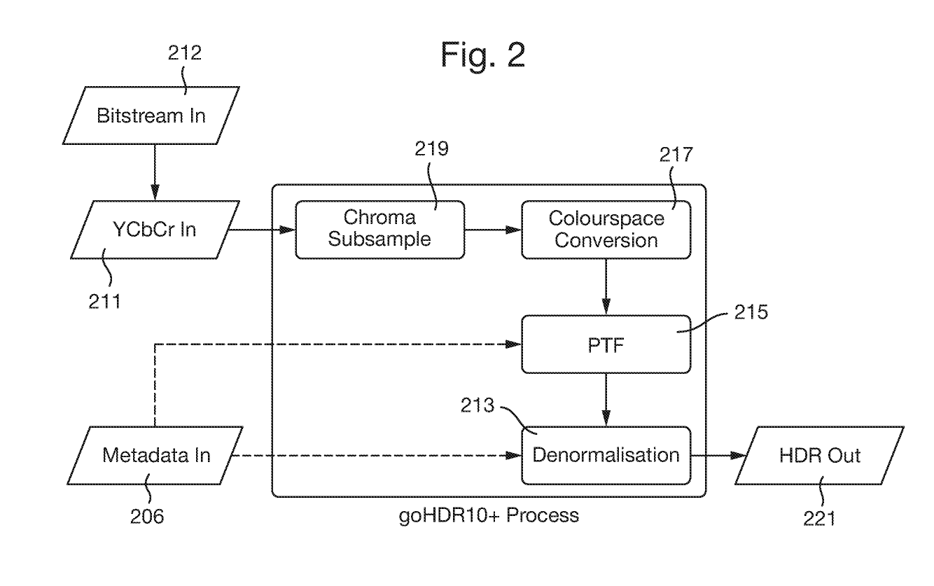

FIG. 2 shows a block diagram of decoding using the present invention to recover encoded HDR;

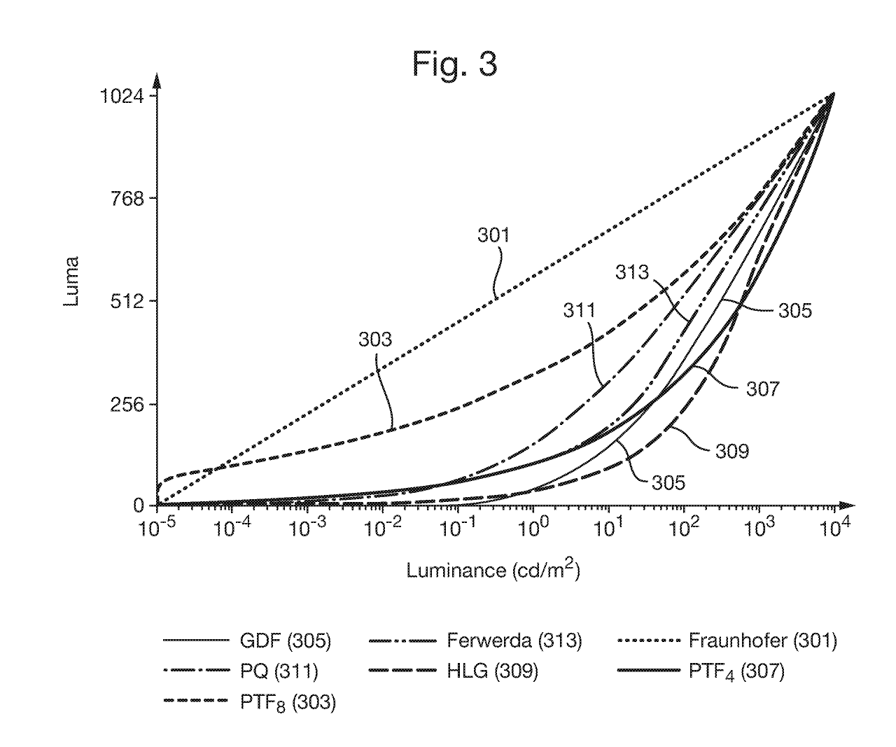

FIG. 3 presents a comparison of just noticeable difference (JND) characteristics of the present invention compared with known prior art methods and standards;

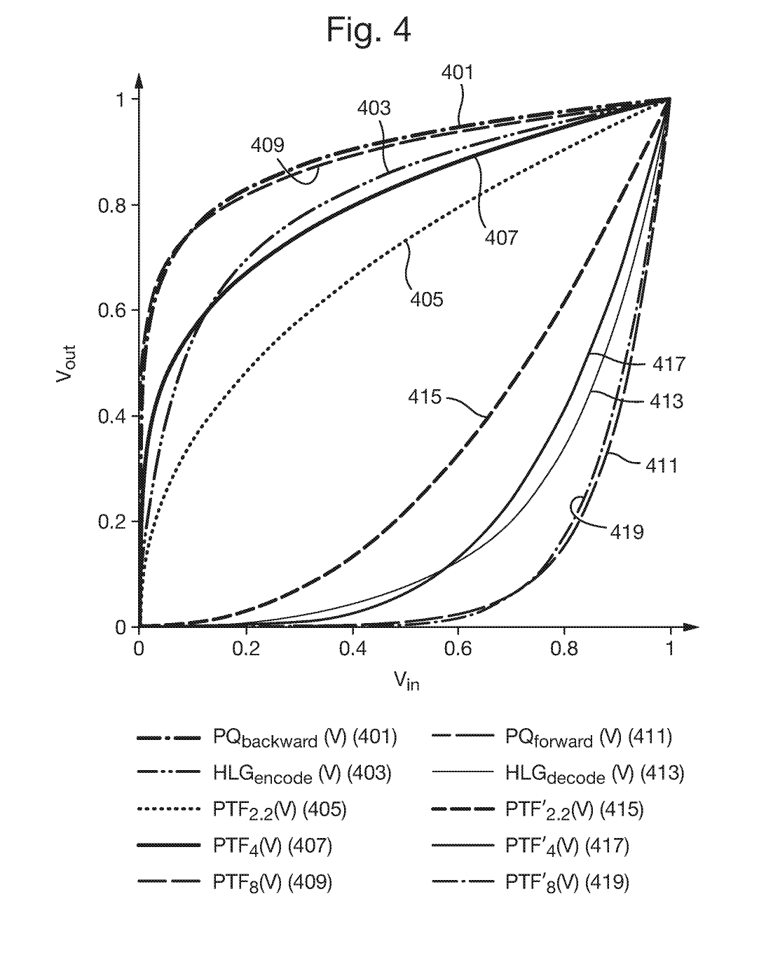

FIG. 4 is a graph showing encoding and decoding transfer functions for transfer functions of the present invention compared with known prior art transfer functions.

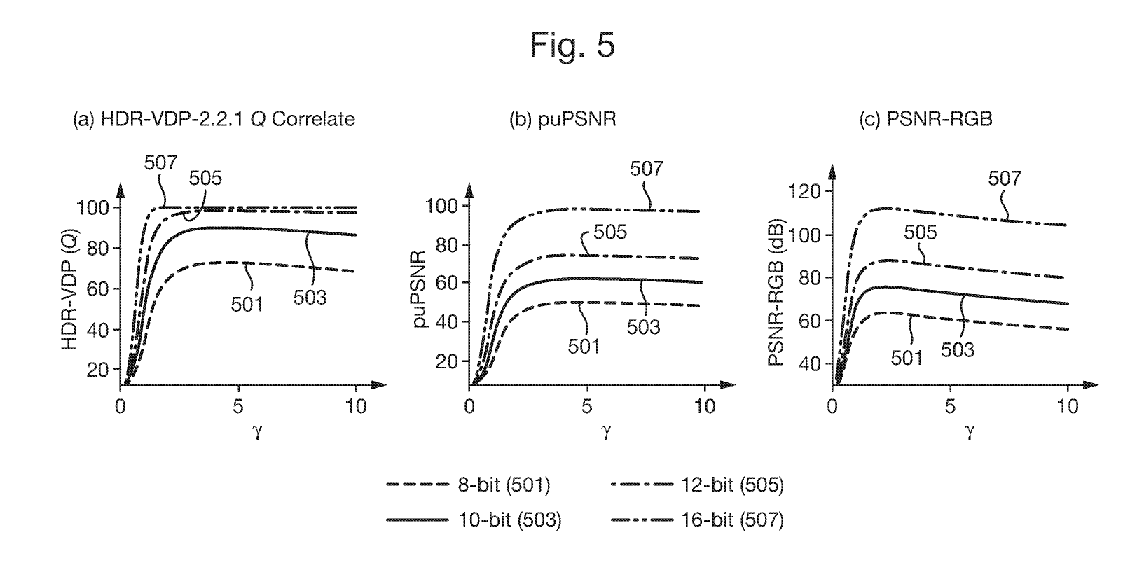

FIG. 5 shows the relationship between γ of the present invention and coding error for power transfer functions created at different bit depts. across a range of metrics;

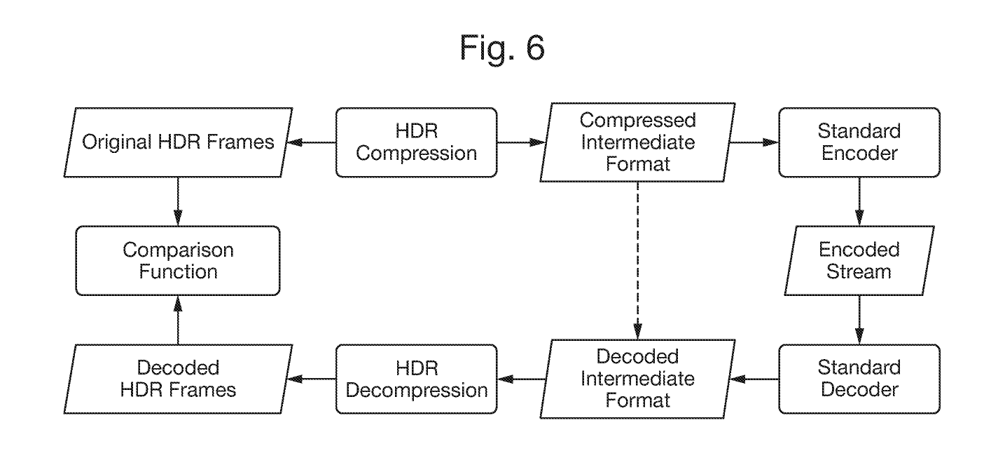

FIG. 6 shows the evaluation pipeline used for comparing compression method of the present invention with known prior art compression methods; and

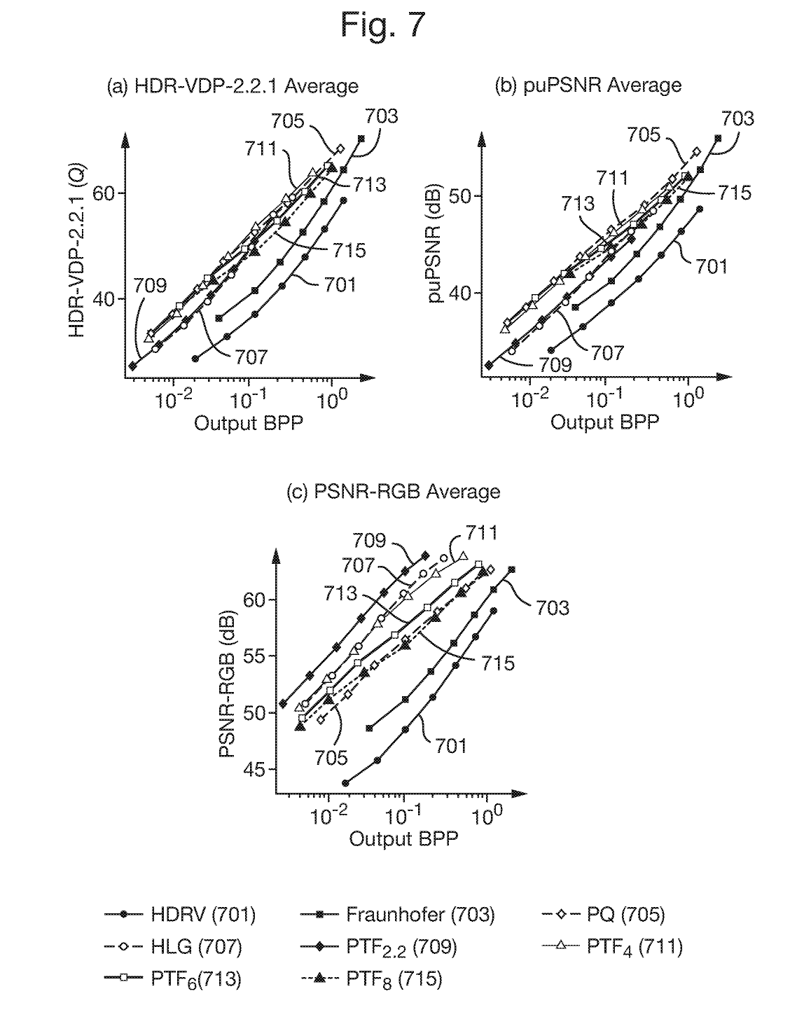

FIG. 7 compares the rate distorted characteristics of the present invention compared to known compression systems.

In FIG. 1 a series of HDR frames 201 is fed as a signal to a normaliser 203, which converts the frames to values between 0 and 1 inclusively. Optionally a metadata calculation 204 is performed on the HDR images to calculate their minima and maxima, these calculations can be fed to the normaliser 204 to assist the normalisation process. The [symbol] normalisation factor calculated is stored 206 to be used in normalising and regrading the video output 211. The normalised HDR image is then compressed 205, using the Power Transfer Function techniques of this invention described above, and the output passed to a normal colour space converter 207 to perform an RGB→YCbCr conversion. The output of the colour space converter 207 is passed to a chroma subsampler 209, which removes some colour detail and so to produce a compressed YCbCr output 211. Optionally this can be converted to a bit stream 212. The inventive concepts is contained in the normaliser 203 and the compression step 205, with or without the added option of the metadata calculation 204 and storage of that calculation 206 for use in normalising and regrading the video output 211.

In a dynamic system, where γ varies from one frame to another depending on brightness and scene content, the output of the metadata calculation 204 can be fed directly into the compression step 205 to enable the optimum value of γ to be varied continuously.

The reversal of this process is shown in FIG. 2 where the converted bit stream or the compressed YCbCr output 211 of FIG. 1 is fed to a chroma subsampler 219 and colour space converter 217 to perform a YCbCr→RGB conversion which is decompressed using the Power Transfer Function techniques of the present invention and denormalised 213 optionally using the stored metadata 206 using the technique described above producing an HDR output 221.

In FIGS. 1 and 2 the dashed lines denote optional processing.

The recent addition of higher bit depth support to commonly used video encoding standards such as Advanced Video Coding (AVC), High Efficiency Video Coding (HEVC) and methods such as VP9 has diminished the need for the known two-stream methods. Thus there is a need to the efficient map HDR data into 10 & 12 bits. For this purpose, the Perceptual Quantizer (PQ) has been proposed is based on the fitting of a polynomial function to the peaks in a model of visual perception. Compression is provided by means of a closer fit to a human visual response curve. PQ uses a perceptual encoding to map the contrast sensitivity of the HVS to the values available in the video stream. This perceptual encoding, however, relies on a complex transfer function.

This invention provides efficient compression and decompression using power transfer functions. Power transfer functions also provide computational benefits, particularly for lower integer powers. To perform the PQ mapping, for example, requires many calculations, however a power transfer function can be computed with a single calculation.

Before video can be compressed with the described technique it must first be normalised to the range [0 1] using a normalisation factor [symbol] . If, for example, the footage has been graded for a monitor with a peak radiance of 10,000 cd/m² then [symbol] =10,000. This normalisation factor must be stored as metadata along with the video data, or otherwise assumed, in order to correctly regrade the footage on decompression. Equations (3) and (4) illustrate the process of normalising and regrading the video.

$$\begin{matrix}{[ \begin{matrix}R \\ G \\ B\end{matrix} ]}_{l} = {[ \begin{matrix}R \\ G \\ B\end{matrix} ]}_{g} \cdot \frac{1}{ℵ} & ( 3 ) \\ {[ \begin{matrix}R \\ G \\ B\end{matrix} ]}_{g} = {[ \begin{matrix}R \\ G \\ B\end{matrix} ]}_{l} \cdot ℵ & ( 4 )\end{matrix}$$

Where [symbol] =normalisation factor; and

$${[ \begin{matrix}\cdot \\ \cdot \\ \cdot \end{matrix} ]}_{l} = linear ; {and [ \begin{matrix}\cdot \\ \cdot \\ \cdot \end{matrix} ]}_{g} = graded$$

To obtain less distortion at the expense of a lower compression ratio, residuals may be stored in a separate stream. This can then be compressed using a number of different residual compression techniques.

Power transfer function is a single stream method, converting HDR input into a single set of compressed output frames. To achieve this compression, power transfer function is utilised in the power function: f(x)=Ax^{γ} where: A is a constant, x is normalised image data contained by the set [symbol] ∈[0,1] and γ∈ [symbol] ⁺.

The straightforward nature of the PTF method is shown in FIGS. 1 and 2 which present the general pipeline into which PTF is used and from Algorithms 1 and 2 which detail the compression and decompression procedures, PTF_{γ} and PTF′_{γ} respectively.

```
Algorithm 1 Power Transfer Encoding
Procedure PTEγ (frames in, [symbol]    )
  For i ← 1, LENGTH (framesᵢₙ) do
      S ← framesᵢₙ[i]
      L ← S/ [symbol]
      V ← L^{1/γ}
      Q ← QUANTISE (V)
      Framesₒᵤₜ[i] ← Q
    end for
    return framesₒᵤₜ , [symbol]
end procedure
```

```
Algorithm 2 Power Transfer Decoding
Procedure PTF′ γ (framesᵢₙ, [symbol]    )
  For i ← 1, LENGTH (framesᵢₙ) do
    Q ← framesᵢₙ[i]
    V ← DEQUANTISE (Q)
    L ← V^{γ}
    S← L - [symbol]
    Q ← Framesₒᵤₜ[i] ← S
  end for
  return framesₒᵤₜ
end procedure
```

Before a HDR video is compressed using PTF, it is normalised to the range [0, 1] with a normalisation factor using the relation L=S/ [symbol] where: S is full range HDR data. If the footage is of an unknown range then it can be analysed in order to determine the correct for encoding, or for live broadcast, can be set to the peak brightness the camera is capable of capturing or the display is capable of presenting. If the normalisation factor is variable, then it can be stored as metadata along with the video data in order to correctly rescale the footage for display. Each input frame may be normalised independently, however this may introduce artefacts as the scaling and nonlinearity can interact and lead to the accumulation of errors when using predicted frames. More often a global or temporal normalisation factor should be used. The metadata can either be passed at the bitstream level, i.e. with supplemental enhancement information (SEI) messages, or at the container level, i.e. MPEG-4 Part 14 (MP4) data streams.

Following compression with PTF, the data must be converted into the output colour space to be passed to the video encoder, and if chroma sub-sampling is to be used, reduced to the correct format.

FIG. 3 is a comparison of just noticeable difference (JND) characteristics from various methods and standards. Greyscale Display Function (GDF) wasdeveloped for the Digital Imaging and Communications in Medicine (DICOM) standard]. This function plots a relationship between luminance and luma such that the contrast steps between each consecutive luma value are not perceptible. The DICOM standard GDF is defined with a lower bound of 1×10⁻¹. As the Fraunhofer method is also based on log luminance it exhibits a purely linear plot on FIG. 3.

To understand how power functions could be adapted for HDR video compression, the just noticeable difference characteristics of power transfer function with the γ values 4 and 8 are shown (lines PTF₄ and PTF₈) in FIG. 3. Integer values of γ were used as it is be be expected that they will exhibit reduced computational cost over non-integer values. The role of γ in the power transfer function is discussed further below. FIG. 3 shows that PTF₄ is a close match to the GDF between 1×10⁻¹ to 1×10⁴ and then provides a smooth transition to the lower bound of our luminance space at 1×10⁻⁵, chosen to provide nearly 30 stops of range. We there-fore expect that PTF4 will provide few noticeable contrast steps without the computational complexity required to implement a perpetual curve. From FIG. 3 it can be seen that HLG is also a close match to the GDF however PQ and PTF₈ both express too few values for the brighter regions of the image. This is especially noticeable with PTF₈ which reserves a large proportion of the available luma values for a region very close to the lower bound. However, this does provide PTF₈ the ability to store a very high dynamic range.

The power function γ used in PTF is similar to Gamma function used in LDR video. However, while LDR Gamma provides even noise suppression over the range of input signal, PTF exploits this power function for HDR video compression. In the prior art, the Gamma finctions used in LDR are generally 2 or less.

FIG. 4 presents a comparison of the shape of the power transfer functions of the present invention in a normalised space compared with known transfer functions. As a linear plot would express no compression, PTF_{2.2} is used as a comparator, as well as accounting for phosphor, it provides a small amount of compression. Mirroring what was presented in FIG. 3, PTF₄ provides a fairly close fit to HLG, and both provide increased compression over LDR Gamma. PTF₈ provides a close fit to PQ and increased compression over PTF₄ and HLG.

In order to evaluate how the efficiency of PTF compares with other proposed methods, it has been compared with the following four state-of-the-art one-stream methods HDRV [reference (1)], Fraunhofer [reference (2)], PQ[reference (3)], and HLG[reference (4)]. For fairness, HDRV and Fraunhofer were adapted from their original presentation for use with a 10-bit video encoder. HDRV was implemented with the luminance range reduced such that the TVI curve could provide a mapping from luminance to 10-bit luma. The Fraunhofer implementation uses Adaptive LogLUV which provides mappings for a flexible number of bits.

These methods were compared on an objective basis. Subsequently, an analysis of the effect of γ on the coding error introduced by compression was considered.

The following three metrics are used to provide results for the evaluation.
PSNR (Peak Signal to Noise Ratio) is one of the most widely used metrics for comparing processed image quality. To adapt the method for HDR imaging, Lₚₑₐₖ was fixed at 10,000 cd/m² and the result was taken as the mean of the channel results.

PSNR_{λ}=20 log₁₀√/((Lₚₑₐₖ)/MSEλ) (5)
puPSNR (Perceptually Uniform PSNR) is an extension to PSNR such that it is capable of handling real-world luminance levels without affecting the results for existing displays. The metric maps the range 1×10⁻⁵ to 1×10⁸ cd/m² in real-world luminance to values that approximate perceptually uniform values derived from a CSF. It is from the remapped luminance that the PSNR is calculated.
HDR-VDP-2.2.1 (HDR Visual Difference Predictor) which is an objective metric based on a detailed model of human vision. The metric estimates the probability at which an average human observer will detect differences between a pair of images in a psychophysical evaluation. The visual model used by this metric takes several aspects of the human visual system into account such intra-ocular light scatter, photo-receptor spectral sensitivities and contrast sensitivity. HDR-VDP-2.2.1 is the objective metric that correlates most highly with subjective studies.

The metrics were calculated for every frame, except HDR-VDP-2.2.1 which was every 10th frame due to its computational expense, and averaged to produce a final figure for the sequence.

FIGS. 5a to 5c show a motivation for the selection of particular values γ by comparing the average distortion introduced by PTF over a range of γ values. All show a generally excellent performance when γ exceeds 2.5 or so, although there is some minor decline in performance once γ exceeds 6 (or a slightly lower figure for the PNSR-RGB performance) suggesting that the optimum value for γ is between 2.5 and 6 inclusive and that γ=4 performs well. The figures show that no advantage is gained by increasing γ above 10. A dataset of 20 HDR images was used for computing the results.

The pipeline used for this analysis is shown in FIG. 6. After compression and colour conversion the images were not passed through the video encoder and were instead immediately decompressed to ascertain just the coding errors introduced by each γ value. The γ values used in the evaluation ranged from 0.25 to 10 and increased in steps of 0.25. The evaluation was performed at four bit-depths: 8, 10, 12 and 16. PSNR-RGB suggests that a γ 2.2 will give the best results. HDR-VDP-2.2.1 Q correlate indicates that a γ of around 4 will perform best and puPSNR a γ of around 6. In FIG. 3 it was seen the PQ transfer function was most closely approximated by a γ value of 8 and hence the value was also tested. As previously mentioned integer values are favoured as the operations required to decode are significantly faster than non-integers. Based on the peaks of the graph, and similarities to the GDF and PQ, the four implementations of power transfer functions chosen for testing were: PTF_{2.2}, PTF₄, PTF₆ and PTF₈.

It is noteworthy in FIG. 5 that the peak in quality does not shift greatly as the bit-depth is increased. This suggests that γ will not need to be changed in an environment of 12 and above bits.

The approach used for quality comparison is out-lined in FIG. 6. For each of the compression methods the pipeline was executed in its entirety. The content is provided as individual HDR frames in OpenEXR format. The compression method's encoding process was run on each of the ten sequences of frames to produce 10-bit files in YCbCr format. These sequences covered a wide range of content types, such as computer graphics renderings, video captured by a SphereonVR HDR Video Camera or an ARRI Alexa. Each scene consisted of 150 frames and was encoded at 24 frames per second. The encoding was conducted with the HEVC encoder x265, due its computational efficiency, and 4:2:0 chroma subsampling with the quantisation parameters QP∈[5, 10, 15, 20, 25, 30, 35]. The Group Of Pictures (GOP) structure contained both bidirectional (B) and predicted (P) frames and the pattern used was (I)BBBP where the intra (I) frame period was 30 frames. The encoded bit streams were then decoded using an HEVC test model reference decoder, and subsequently using the individual compression method's decoding process.

FIGS. 7a to 7c show the results for each of the tested methods for the three quality metrics. On each of the figures an increase on the Y axis indicates improved objective quality, and a decrease on the X axis indicates reduced bit-rate. Therefore results closest to the top-left corner are preferred. For each method at each QP, the average BPP of the encoded bit streams across all sequences was calculated and plotted against the average quality measured. The ten HDR video sequences were used to test the compression methods.

The rate-distortion plots shown in FIG. 7 present the trade-off between bit-rate and quality for each method. If a plotted line maintains a position above another, this indicates that improved quality can be consistently obtained from a method even with a reduction in bitrate.

These figures show that PTF_{2.2} achieves the highest average PSNR followed by HLG then PTF₄. As PSNR does not perceptually weight the error encountered, PTF_{2.2} is rated highly. This is because the close to linear mapping provided by PTF_{2.2} reduces error in the bright regions while failing to preserve detail in the dark regions. The reduced error on the relatively large values found in the bright regions therefore favour PTF_{2.2} when tested with PSNR.

HDR-VDP-2.2.1 and puPSNR use perceptual weightings that recognise that error in the dark regions is more noticeable to the HVS than the error in the bright regions. These metrics show that on average PTF₄ exhibits the least error for a given bit-rate than the other methods, although for certain sequences, PTF₆ achieved the highest quality. PTF₄ weights error in the dark regions more highly than PTF_{2.2} but less highly than PTF₆ or PTF₈.

The Bjøntegaard delta metric [reference (5)] calculates the average difference in quality between pairs of methods encoding sequences at the same bit-rate. Using this metric, it is possible to determine the average HDR-VDP-2.2.1 Q correlate gain over the range of bit-rates achieved by PTF when compared with the other methods evaluated. From Table 1 it can be seen that PTF₄ gained 0.32 over PQ, 2.90 over HLG, 7.28 over Fraunhofer and 13.35 over HDRV. It can also be seen that PTF₄ gained 0.96 over PTF₆, 2.24 over PTF₈ and 2.39 over PTF_{2.2}. A useful feature of PTF is its adaptability which enables the use of different γ values in order to provide the best performance for particular sequences.

TABLE 1
Bjøntegaard delta VPD results showing the average improvement
in HDR-VDP-2.2.1 Q correlate results between
pairs of methods over ten sequences.

| | PTF_{2.2} | PTF₄ | PTF₆ | PTF₈ | HDRV | Fraunhofer | PQ | HLG |
|---|---|---|---|---|---|---|---|---|
| PTF_{2.2} | — | −2.39 | −1.11 | 0.14 | 11.32 | 5.65 | −1.18 | 0.42 |
| PTF₄ | 2.39 | — | 0.96 | 2.24 | 13.35 | 7.28 | 0.32 | 3.90 |
| PTF₆ | 1.11 | −0.96 | — | 1.30 | 12.52 | 6.74 | −0.62 | 1.58 |
| PTF₈ | −0.14 | −2.24 | −1.30 | — | 11.18 | 5.42 | −1.91 | 0.20 |
| HDRV | −11.32 | −13.35 | −12.52 | −11.18 | — | −5.10 | −13.64 | −11.39 |
| Fraunhofer | −5.65 | −7.28 | −6.74 | −5.42 | 5.10 | — | −7.95 | −5.87 |
| PQ | 1.18 | −0.32 | 0.62 | 1.91 | 13.64 | 7.95 | — | 1.93 |
| HLG | −0.42 | −2.90 | −1.58 | −0.30 | 11.39 | 5.87 | −1.93 | — |

In Table 1 positive numbers denote a HDR-VDP-2.2.1 Q correlate improvement on average over the range of bit-rates exhibited by the method in the left hand column over the method at the column heading, negative numbers the reverse. As can be seen PTF₄ showed improvement over all other methods

High performance is essential for real-world encoding and decoding. With that in mind a comparison was made between PTF and an analytical implementation of PQ and against look-up tables (LUTs).

Table 2 shows the decoding performance of PTF′₄ and PQ and their LUT equivalents, PTF′₄ and their LUT equivalents, used in compiling Table 2. The 1D LUTs were generated by storing the result of each transfer function for every 10-bit input value and the result stored in a floating-point array. The scaling required to reconstruct the full HDR frame was also included in the table to improve performance resulting in a mapping from 10-bit compressed RGB to full HDR floating-point. The results were produced by a single-threaded C++ implementation compiled with the Intel C++ Compiler v16.0. Only the inner loop was timed so disk read and write speeds are not taken into account. Each result was taken as the average of five tests per method on each sequence to reduce the variance associated with CPU timing. The software was compiled with the AVX2 instruction set with automatic loop-unrolling, O3 optimisations and fast floating-point calculations. The machine used to run the performance tests was an Intel Xeon E3-1245v3 running at 3.4 GHz with 16 GB of RAM and running the Microsoft Windows 8.1 x86-64 operating system.

TABLE 2
Differences in decoding time between PTF′₄, PQ_{forward}
and their LUT equivalents across a range of sequences
and average over five tests per sequence.

| | Time per Frame (ms) | | | | Speed Up (ratio) | |
|---|---|---|---|---|---|---|
| | Analytic | | LUT | | PTF′₄ | |
| Video Image | PTF′₄ | PQ | PTF′₄ | PQ | PQ | LUT |
| Welding | 2.57 | 66.37 | 4.13 | 3.95 | 25.85 | 1.61 |
| Jaguar Car | 2.73 | 66.78 | 3.92 | 3.87 | 24.47 | 1.44 |
| River Seine | 2.58 | 64.01 | 3.92 | 3.92 | 24.86 | 1.52 |
| Tears of Steel | 2.69 | 98.08 | 3.95 | 3.91 | 36.49 | 1.47 |
| Mercedes Car | 2.72 | 73.57 | 3.80 | 3.95 | 27.00 | 1.39 |
| Beer festival | 2.61 | 65.16 | 3.73 | 3.81 | 24.92 | 1.43 |
| Carousel | 2.54 | 65.91 | 3.77 | 3.93 | 25.79 | 1.48 |
| Fireworks | | | | | | |
| Bistro | 2.63 | 65.85 | 3.82 | 3.95 | 25.00 | 1.45 |
| Fireplace | 2.31 | 129.84 | 3.66 | 3.86 | 56.22 | 1.58 |
| Showgirl | 2.70 | 69.39 | 3.89 | 3.99 | 25.69 | 1.44 |
| Average | 2.61 | 76.50 | 3.86 | 3.91 | 29.63 | 1.48 |

In table 3 the tests were performed on a workstations PC. Speed up is the ratio between PTF′₄ and PQ_{forward}, and between PTF′4 and its LUT implementation. As can be seen PTF′₄ achieves a very considerable improvement over PQ_{forward}, this is a direct result of the much reduced computational time required by PTF′₄. The encoding performance was also evaluated for the various methods. In this case the mapping was from full HDR floating-point to 10-bit output and hence the LUT implementations could not include scaling in the table. The sequences, resolution and sequence lengths were the same as above. PTF₄ encoding was achieved on average per frame in 4.37 ms, PQ encoding in 72.59 ms, PTF₄ LUT in 4.02 ms and PQ LUT in 4.21 ms.

The results demonstrate that the straightforward floating-point calculations required to decode PTF₄ can outperform the floating-point calculations required to decode PQ by a factor of 29.63 times and even the indexing needed to use a look-up table by 1.48 times. The high performance of PTF′₄ is due to its compilation into only a few instructions, in this case three multiplies, that can have high performance SIMD implementations. PTF also avoids any branching, improving performance on pipelined architectures. Encoding PTF₄ can be achieved at a speed comparable to the use of LUT and greatly in excess of an analytic implementation of PQ.

The foregoing discussion shows that a transfer function based on power functions in accordance with the invention produces high quality HDR video compression. The use of PTF₄ correlates well with a theoretical CSF function. Furthermore, PTF is of capable of producing high quality video compressed HDR video and that the compression can be achieved using straightforward techniques which lend themselves to implementation in real-time and low-power environments. On a commodity desktop machine, PTF is capable of being decoded at over 380 fps and outperforms an analytic implementation of PQ by a factor of over 29.5 and a look-up implementation by a factor of nearly 1.5. Encoding performance outperforms PQ by a factor of 16.6 and is only slightly slower than a LUT. Thanks to its straightforward nature, PTF is capable of acceleration through the use of hardware such as FPGAs and GPUs.

### REFERENCES

(1) HDRV: Mantiuk et al: Perception motivated hugh dynamic range video encoding. ACM Transactions on Graphics (TOG) vol 23 pp7233-741. ACM (2004).
(2) Fraunhofer: Garbas and Thoma: Temporally coherant luminescent-to-luma mapping for high dynamic range video coding with H.264/AVC. In ICASSP PP 829-832. IEEE (2011).
(3) PQ: Miller et al: Perceptual signal coding for more efficient usage of bit codes. SMPTE Conferences vol 2012 pp 1-9 (2012).
(4) HLG: Borer: Non-linear opto-electrical transfer functions for high dynamic range television.
(5) Bjøntegaard: Calculation of average psnr differences between rd-curves. VCEG-M33 ITU-T q6/16, Austin Tex., USA 2-4 Apr. 2001 (2001).

1. A method of compressing and decompressing High Dynamic Range images comprising the step of using a power function ƒ(x)=Ax^{γ} in which A is a constant, x is normalised image data contained by the set [symbol] ∈[0,1] and γ∈ [symbol] ⁺ and in which γ is 2.5 or greater.

2. A method of compressing and decompressing High Dynamic Range images according to claim 1 in which a desired value of γ is rounded to the nearest whole number.

3. A method of compressing and decompressing High Dynamic Range images according to claim 1 in which γ is between 2.5 and 10 inclusive.

4. A method of compressing and decompressing High Dynamic Range images according to claim 1 in which γ is 6 or 8.

5. A method of compressing and decompressing High Dynamic Range images according to claim 1 in which γ is 4.

6. A method of compressing and decompressing High Dynamic Range images according to claim 1 in which γ is varied between frames.

7. A method of compressing and decompressing High Dynamic Range images according to claim 1 in which γ is calculated using a scene related histogram relating content to bit depth from a best fit to the current regression curve derived from said histogram.

8. (canceled)
